(19) United States
(12) Patent Application Publication
(10) Pub. No.: US 2014/0322570 A1
(43) Pub. Date: Oct. 30, 2014

(54) VEHICLE

(71) Applicants: Toru Nakamura, Toyota-shi (JP); Shinji Ichikawa, Toyota-shi (JP)

(72) Inventors: Toru Nakamura, Toyota-shi (JP); Shinji Ichikawa, Toyota-shi (JP)

(73) Assignee: TOYOTA JIDOSHA KABUSHIKI KAISHA, Toyota-shi, Aichi-ken (JP)

(21) Appl. No.: 14/361,480

(22) PCT Filed: Dec. 22, 2011
(86) PCT No.: PCT/JP2011/079774

§ 371 Date: May 29, 2014

(51) Int. Cl. H01M 10/625

(52) U.S. Cl. CPC H01M 10/5016; H01M 2220/20
USPC 429/72; 429/120

(57) ABSTRACT

This vehicle incorporates a battery including a battery charged with external electric power, a charging-related device including a charging device used for charging of the battery, and a first coolant device introducing a coolant for cooling the battery and the charging device into the battery and the charging-related device, and the first coolant device is provided to allow switching between a first state in which the coolant is introduced into the battery and a second state in which the coolant is introduced into the charging-related device.

### TECHNICAL FIELD

The present invention relates to a vehicle incorporating a battery charged with external electric power.

### BACKGROUND ART

A hybrid vehicle, an electric car, and the like in which drive wheels are driven with electric power from a battery or the like have recently attracted attention in consideration of environments.

In particular in recent years, for an electrically powered vehicle incorporating a battery as above, wireless charging with which a battery can be charged in a non-contact manner without using a plug or the like has attracted attention. Recently, various charging schemes have been proposed also for non-contact charging schemes.

For example, Japanese Patent Laying-Open No. 2010-268660 (PTD 1), Japanese Patent Laying-Open No. 2011-098632 (PTD 2), and Japanese Patent Laying-Open No. 2007-141660 (PTD 3) are exemplified as electric power transmission systems employing a non-contact charging scheme.

In PTD 1, a cooling device for cooling a coil provided in an electric power reception device is provided. PTD 2 discloses a structure for cooling a charger. PTD 3 discloses a structure for cooling a battery pack.

In a case that a contact charging device or a wireless charging device is mounted on a vehicle, a coolant device for cooling a battery and cooling a charging-related device used for charging of the battery is required.

### CITATION LIST

### Patent Document

PTD 1: Japanese Patent Laying-Open No. 2010-268660
PTD 2: Japanese Patent Laying-Open No. 2011-098632
PTD 3: Japanese Patent Laying-Open No. 2007-141660

### SUMMARY OF INVENTION

### Technical Problem

For example, in a case that each cooling device disclosed in each document above is mounted on a vehicle, the individually provided cooling device cools only a target device, and that cooling device is not made use of while a target device is not cooled.

Therefore, the present invention was made to solve the problems described above, and provides a vehicle in which a coolant introduction device for cooling a battery and cooling a charging-related device used for charging of the battery can efficiently be made use of.

### Solution to Problem

A vehicle based on the present invention includes a battery charged with external electric power, a charging device used for charging of the battery, and a first coolant device for introducing a coolant for cooling the battery and the charging device into the battery and the charging device. The first coolant device is provided to allow switching between a first state in which the coolant is introduced mainly into the battery and a second state in which the coolant is introduced mainly into the charging device.

In another form, the first coolant device includes a main coolant flow path in which the coolant is introduced, a flow path switching device provided in the main coolant flow path, a first coolant flow path provided in the flow path switching device and leading to the battery, and a second coolant flow path provided in the flow path switching device and leading to the charging device. The flow path switching device is provided to allow switching between the first state in which the first coolant flow path is allowed to communicate with the main coolant flow path to introduce the coolant mainly into the battery and the second state in which the second coolant flow path is allowed to communicate with the main coolant flow path to introduce the coolant mainly into the charging device.

In another form, when cooling of the battery is necessary and cooling of the charging device is not necessary, the first state is selected for the first coolant device.

In another form, the battery further includes a second coolant device for introducing a coolant for cooling the battery.

In another form, when the first state is selected, the coolant is introduced into the battery by using the second coolant device.

In another form, when the first state is selected, the coolant is introduced into the battery by using the second coolant device.

In another form, the second coolant device is lower in cooling capability than the first coolant device.

In another form, the second state is selected during charging of the battery with the external electric power.

In another form, the charging device includes an electric power reception device receiving electric power in a non-contact manner from an externally provided electric power transmission portion.

### Advantageous Effects of Invention

According to this invention, a vehicle in which a coolant introduction device mounted on the vehicle for cooling a battery and cooling a charging-related device used for charging of the battery can efficiently be made use of can be provided.

### BRIEF DESCRIPTION OF DRAWINGS

FIG. 1 is a diagram schematically illustrating a vehicle incorporating an electric power transmission device, an electric power reception device, and an electric power transmission system in a first embodiment.

FIG. 2 is a diagram showing a simulation model of the electric power transmission system.

FIG. 3 is a diagram showing simulation results.

FIG. 4 is a diagram showing relation between electric power transmission efficiency at the time when an air gap is varied while a natural frequency is fixed and a frequency f of a current supplied to a resonant coil.

FIG. 5 is a diagram showing relation between a distance from a current source (magnetic current source) and intensity of electromagnetic field.

FIG. 6 is a schematic diagram showing a construction of a first coolant device mounted on the vehicle in the first embodiment.

FIG. 7 is a diagram showing a detailed construction and a first state of a flow path switching device of the first coolant device mounted on the vehicle in the first embodiment.

FIG. 8 is a diagram showing a second state of the flow path switching device of the first coolant device mounted on the vehicle in the first embodiment.

FIG. 9 is a diagram showing a third state of the flow path switching device of the first coolant device mounted on the vehicle in the first embodiment.

FIG. 10 is a schematic diagram showing a construction of a first coolant device and a second coolant device mounted on the vehicle in a second embodiment.

FIG. 11 is a diagram showing a detailed construction and a first state of a flow path switching device of the first coolant device mounted on the vehicle in the second embodiment.

FIG. 12 is a diagram showing a second state of the flow path switching device of the first coolant device mounted on the vehicle in the second embodiment.

FIG. 13 is a diagram showing a third state of the flow path switching device of the first coolant device mounted on the vehicle in the second embodiment.

FIG. 14 is a perspective view showing a construction of the vehicle in a third embodiment.

FIG. 15 is a diagram showing a circuit of an electric power reception device, a charger, a charging control unit, and a battery mounted on the vehicle in the third embodiment.

FIG. 16 is a schematic diagram showing a construction of a first coolant device mounted on the vehicle in the third embodiment.

FIG. 17 is a diagram showing another form of an electric power transmission system.

### DESCRIPTION OF EMBODIMENTS

A vehicle incorporating an electric power transmission device, an electric power reception device, and an electric power transmission system in an embodiment based on the present invention will be described hereinafter with reference to the drawings. It is noted that, when the number, an amount or the like is mentioned in each embodiment described below, the scope of the present invention is not necessarily limited to the number, the amount or the like, unless otherwise specified. In addition, the same or corresponding elements have the same reference characters allotted and redundant description may not be repeated. Moreover, combination for use of features in each embodiment as appropriate is originally intended.

### First Embodiment

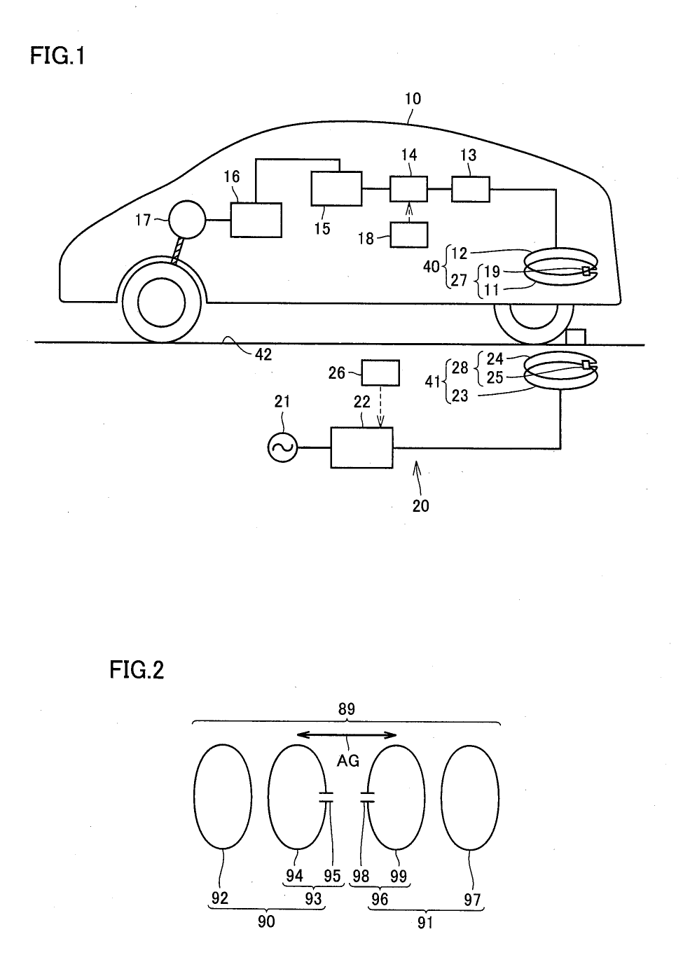

A vehicle incorporating an electric power transmission system according to the present embodiment will be described with reference to FIG. 1. FIG. 1 is a diagram schematically illustrating a vehicle incorporating an electric power transmission device, an electric power reception device, and an electric power transmission system in an embodiment.

The electric power transmission system according to the present first embodiment has an electrically powered vehicle 10 including an electric power reception device 40 and an external power feed device 20 including an electric power transmission device 41. Electric power reception device 40 of electrically powered vehicle 10 mainly receives electric power from electric power transmission device 41 as a car stops at a prescribed position in a parking space 42 provided with electric power transmission device 41.

In parking space 42, a chock or a line indicating a parking position and a parking area is provided so as to stop electrically powered vehicle 10 at the prescribed position.

External power feed device 20 includes a high-frequency electric power driver 22 connected to an AC power supply 21, a control unit 26 controlling drive of high-frequency electric power driver 22 and the like, and electric power transmission device 41 connected to this high-frequency electric power driver 22. Electric power transmission device 41 includes an electric power transmission portion 28 and an electromagnetic induction coil 23. Electric power transmission portion 28 includes a resonant coil 24 and a capacitor 25 connected to resonant coil 24. Electromagnetic induction coil 23 is electrically connected to high-frequency electric power driver 22. Though capacitor 25 is provided in the example shown in this FIG. 1, capacitor 25 is not necessarily an essential feature.

Electric power transmission portion 28 includes an electric circuit formed from an inductance of resonant coil 24 as well as a stray capacitance of resonant coil 24 and a capacitance of capacitor 25.

Electrically powered vehicle 10 includes electric power reception device 40, a rectifier 13 connected to electric power reception device 40, a DC/DC converter 14 connected to this rectifier 13, a battery 15 connected to this DC/DC converter 14, a power control unit (PCU) 16, a motor unit 17 connected to this power control unit 16, and a vehicle ECU (Electronic Control Unit) 18 controlling drive of DC/DC converter 14, power control unit 16, or the like. It is noted that electrically powered vehicle 10 according to the present embodiment is a hybrid vehicle including a not-shown engine, however, it includes also an electric car and a fuel cell vehicle so long as a vehicle is driven by a motor.

Rectifier 13 is connected to an electromagnetic induction coil 12 and converts an AC current supplied from electromagnetic induction coil 12 to a DC current and supplies the DC current to DC/DC converter 14.

DC/DC converter 14 regulates a voltage of the DC current supplied from rectifier 13 and supplies the resultant DC current to battery 15. It is noted that DC/DC converter 14 is not an essential feature and no DC/DC converter may be provided. In this case, by providing a matching device for impedance matching with external power feed device 20 between electric power transmission device 41 and high-frequency electric power driver 22, DC/DC converter 14 can be substituted for.

Power control unit 16 includes a converter connected to battery 15 and an inverter connected to this converter, and the converter regulates (boosts) a DC current supplied from battery 15 and supplies the resultant DC current to the inverter. The inverter converts the DC current supplied from the converter to an AC current and supplies the AC current to motor unit 17.

For example, a three-phase AC motor or the like is adopted as motor unit 17, and motor unit 17 is driven by an AC current supplied from the inverter of power control unit 16.

It is noted that, in a case that electrically powered vehicle 10 is a hybrid vehicle, electrically powered vehicle 10 further includes an engine. Motor unit 17 includes a motor generator mainly functioning as a generator and a motor generator mainly functioning as a motor.

Electric power reception device 40 includes an electric power reception portion 27 and electromagnetic induction coil 12. Electric power reception portion 27 includes a resonant coil 11 and a capacitor 19. Resonant coil 11 has a stray capacitance. Therefore, electric power reception portion 27 has an electric circuit formed from an inductance of resonant coil 11 and capacitances of resonant coil 11 and capacitor 19. It is noted that capacitor 19 is not an essential feature and no capacitor can be provided.

In the electric power transmission system according to the present embodiment, a difference in natural frequency between electric power transmission portion 28 and electric power reception portion 27 is not higher than 10% of the natural frequency of electric power reception portion 27 or electric power transmission portion 28. By setting a natural frequency of each of electric power transmission portion 28 and electric power reception portion 27 within such a range, electric power transmission efficiency can be enhanced. On the other hand, when a difference in natural frequency is higher than 10% of the natural frequency of electric power reception portion 27 or electric power transmission portion 28, electric power transmission efficiency is lower than 10% and such a disadvantage as a longer period of time for charging of battery 15 is caused.

Here, a natural frequency of electric power transmission portion 28 means an oscillation frequency in a case that an electric circuit formed from an inductance of resonant coil 24 and a capacitance of resonant coil 24 when capacitor 25 is not provided freely oscillates. When capacitor 25 is provided, a natural frequency of electric power transmission portion 28 means an oscillation frequency in a case that an electric circuit formed from capacitances of resonant coil 24 and capacitor 25 and an inductance of resonant coil 24 freely oscillates. A natural frequency at the time when braking force and electric resistance are set to zero or substantially zero in the electric circuit above is also referred to as a resonance frequency of electric power transmission portion 28.

Similarly, a natural frequency of electric power reception portion 27 means an oscillation frequency in a case that an electric circuit formed from an inductance of resonant coil 11 and a capacitance of resonant coil 11 when no capacitor 19 is provided freely oscillates. When capacitor 19 is provided, a natural frequency of electric power reception portion 27 means an oscillation frequency in a case that an electric circuit formed from capacitances of resonant coil 11 and capacitor 19 and an inductance of resonant coil 11 freely oscillates. A natural frequency at the time when braking force and electrical resistance are set to zero or substantially zero in the electric circuit is also referred to as a resonance frequency of electric power reception portion 27.

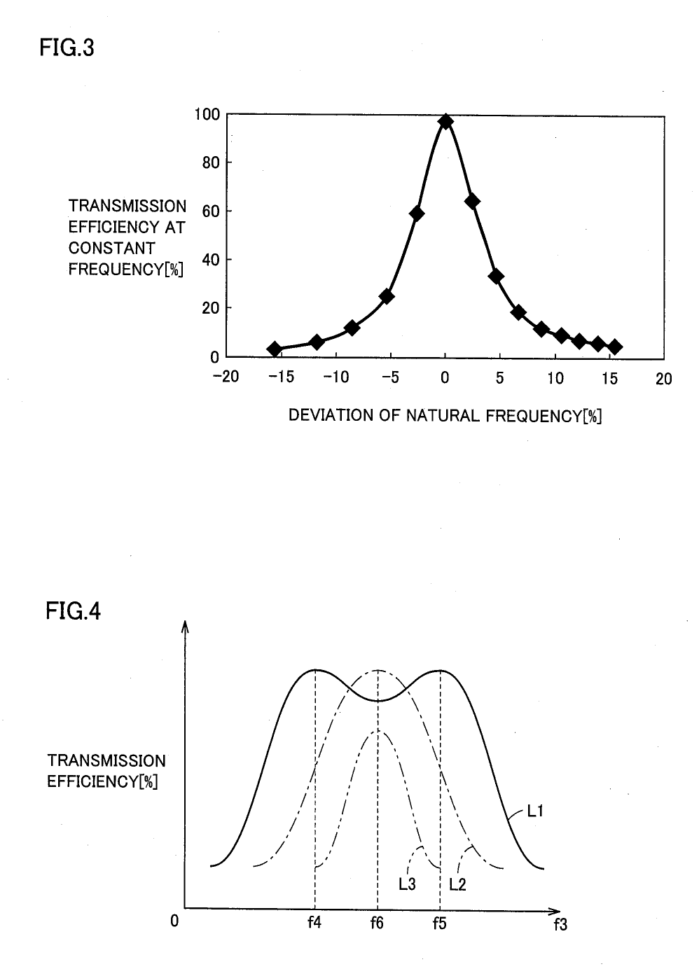

Simulation results from analysis of relation between a difference in natural frequency and electric power transmission efficiency will be described with reference to FIGS. 2 and 3. FIG. 2 shows a simulation model of the electric power transmission system. An electric power transmission system 89 includes an electric power transmission device 90 and an electric power reception device 91 and electric power transmission device 90 includes an electromagnetic induction coil 92 and an electric power transmission portion 93. Electric power transmission portion 93 includes a resonant coil 94 and a capacitor 95 provided in resonant coil 94.

Electric power reception device 91 includes an electric power reception portion 96 and an electromagnetic induction coil 97. Electric power reception portion 96 includes a resonant coil 99 and a capacitor 98 connected to this resonant coil 99.

An inductance of resonant coil 94 is denoted as an inductance Lt and a capacitance of capacitor 95 is denoted as a capacitance C1. An inductance of resonant coil 99 is denoted as an inductance Lr and a capacitance of capacitor 98 is denoted as a capacitance C2. With setting of each parameter as such, a natural frequency f1 of electric power transmission portion 93 is expressed in an equation (1) below and a natural frequency f2 of electric power reception portion 96 is expressed in an equation (2) below.

f1=1/{2π(Lt×C1)^{1/2}} (1)

f2=1/{2π(Lr×C2)^{1/2}} (2)

Here, relation between deviation in natural frequency between electric power transmission portion 93 and electric power reception portion 96 and electric power transmission efficiency in a case that inductance Lr and capacitances C1, C2 are fixed and only inductance Lt is varied is shown in FIG. 3. It is noted that, in this simulation, relative positional relation between resonant coil 94 and resonant coil 99 is fixed and in addition, a frequency of a current supplied to electric power transmission portion 93 is constant.

In the graph shown in FIG. 3, the abscissa represents deviation (%) in natural frequency and the ordinate represents transmission efficiency (%) at a constant frequency. Deviation (%) in natural frequency is expressed in an equation (3) below.

(Deviation in Natural Frequency)={(f1−f2)/f2}×100(%) (3)

As is clear also from FIG. 3, when deviation (%) in natural frequency is ±0%, electric power transmission efficiency is close to 100%. When deviation (%) in natural frequency is ±5%, electric power transmission efficiency is 40%. When deviation (%) in natural frequency is ±10%, electric power transmission efficiency is 10%. When deviation (%) in natural frequency is ±15%, electric power transmission efficiency is 5%. Namely, it can be seen that electric power transmission efficiency can be enhanced by setting a natural frequency of each of the electric power transmission portion and the electric power reception portion such that an absolute value of deviation (%) in natural frequency (difference in natural frequency) is not greater than 10% of the natural frequency of electric power reception portion 96. In addition, it can be seen that electric power transmission efficiency can further be enhanced by setting a natural frequency of each of the electric power transmission portion and the electric power reception portion such that an absolute value of deviation (%) in natural frequency is not higher than 5% of the natural frequency of electric power reception portion 96. It is noted that electromagnetic field analysis software (JMAG (trademark): manufactured by JSOL Corporation)) is adopted as simulation software.

An operation of the electric power transmission system according to the present embodiment will now be described.

In FIG. 1, electromagnetic induction coil 23 is supplied with AC power from high-frequency electric power driver 22. As a prescribed AC current flows through electromagnetic induction coil 23, the AC current also flows through resonant coil 24 based on electromagnetic induction. Here, electric power is supplied to electromagnetic induction coil 23 such that a frequency of the AC current which flows through resonant coil 24 attains to a specific frequency.

As a current of a specific frequency flows through resonant coil 24, electromagnetic field oscillating at a specific frequency is formed around resonant coil 24.

Resonant coil 11 is arranged within a prescribed range from resonant coil 24, and resonant coil 11 receives electric power from electromagnetic field formed around resonant coil 24.

In the present embodiment, what is called a helical coil is adopted for resonant coil 11 and resonant coil 24. Therefore, magnetic field oscillating at a specific frequency is mainly formed around resonant coil 24, and resonant coil 11 receives electric power from that magnetic field.

Here, magnetic field at a specific frequency formed around resonant coil 24 will be described. “Magnetic field at a specific frequency” typically has relationship with electric power transmission efficiency and a frequency of a current supplied to resonant coil 24. Therefore, initially, relation between electric power transmission efficiency and a frequency of a current supplied to resonant coil 24 will be described. Electric power transmission efficiency at the time when electric power is transmitted from resonant coil 24 to resonant coil 11 varies depending on various factors such as a distance between resonant coil 24 and resonant coil 11. For example, a natural frequency (resonance frequency) of electric power transmission portion 28 and electric power reception portion 27 is defined as a natural frequency fly, a frequency of a current supplied to resonant coil 24 is defined as a frequency f3, and an air gap between resonant coil 11 and resonant coil 24 is defined as an air gap AG.

FIG. 4 is a graph showing relation between electric power transmission efficiency at the time when air gap AG is varied while natural frequency f0 is fixed and frequency f3 of a current supplied to resonant coil 24.

In the graph shown in FIG. 4, the abscissa represents frequency f3 of a current supplied to resonant coil 24 and the ordinate represents electric power transmission efficiency (%). An efficiency curve L1 schematically shows relation between electric power transmission efficiency at the time when air gap AG is small and frequency f3 of a current supplied to resonant coil 24. As shown with this efficiency curve L1, when air gap AG is small, a peak of electric power transmission efficiency appears at frequencies f4, f5 (f4<f5). As air gap AG is increased, two peaks at which electric power transmission efficiency is high are varied to be close to each other. Then, as shown with an efficiency curve L2, when air gap AG is greater than a prescribed distance, one peak of electric power transmission efficiency appears, and electric power transmission efficiency attains to a peak when a frequency of a current supplied to resonant coil 24 attains to a frequency f6. As air gap AG is further increased as compared with the state shown with efficiency curve L2, the peak of electric power transmission efficiency is lower as shown with an efficiency curve L3.

For example, a first technique as follows is possible as a technique for improving electric power transmission efficiency. As a first technique, a technique of varying characteristics of electric power transmission efficiency between electric power transmission portion 28 and electric power reception portion 27 by maintaining a frequency of a current supplied to resonant coil 24 shown in FIG. 1 constant in accordance with air gap AG and varying a capacitance of capacitor 25 or capacitor 19 is possible. Specifically, capacitances of capacitor 25 and capacitor 19 are adjusted such that electric power transmission efficiency attains to peak while a frequency of a current supplied to resonant coil 24 is maintained constant. With this technique, regardless of a size of air gap AG, a frequency of a current which flows through resonant coil 24 and resonant coil 11 is constant. It is noted that a technique of making use of a matching device provided between electric power transmission device 41 and high-frequency electric power driver 22, a technique of making use of converter 14, or the like can also be adopted as a technique of varying characteristics of electric power transmission efficiency.

A second technique is a technique of adjusting a frequency of a current supplied to resonant coil 24 based on a size of air gap AG. For example, in a case that electric power transmission characteristics exhibit efficiency curve L1 in FIG. 4, a current having a frequency of frequency f4 or frequency f5 is supplied to resonant coil 24. Then, in a case that frequency characteristics exhibit efficiency curve L2, L3, a current having a frequency of frequency f6 is supplied to resonant coil 24. In this case, a frequency of a current which flows through resonant coil 24 and resonant coil 11 is varied in accordance with a size of air gap AG.

With the first technique, a frequency of a current which flows through resonant coil 24 attains to a fixed constant frequency, and with the second technique, a frequency which flows through resonant coil 24 attains to a frequency which varies as appropriate depending on air gap AG. With the first technique, the second technique, or the like, a current at a specific frequency set to achieve high electric power transmission efficiency is supplied to resonant coil 24. As a current at a specific frequency flows through resonant coil 24, magnetic field (electromagnetic field) oscillating at a specific frequency is formed around resonant coil 24. Electric power reception portion 27 receives electric power from electric power transmission portion 28 through magnetic field formed between electric power reception portion 27 and electric power transmission portion 28 and oscillating at a specific frequency. Therefore, “magnetic field oscillating at a specific frequency” is not necessarily magnetic field at a fixed frequency. Though a frequency of a current supplied to resonant coil 24 is set with attention being paid to air gap AG in the example above, electric power transmission efficiency is varied also by other factors such as displacement in a horizontal direction of resonant coil 24 and resonant coil 11, and a frequency of a current supplied to resonant coil 24 may be adjusted based on those other factors.

Though an example in which a helical coil is adopted for a resonant coil has been described in the present embodiment, in a case that an antenna such as a meandering line is adopted for a resonant coil, a current at a specific frequency flows through resonant coil 24 and thus electric field at a specific frequency is formed around resonant coil 24. Then, electric power is transmitted between electric power transmission portion 28 and electric power reception portion 27 through this electric field.

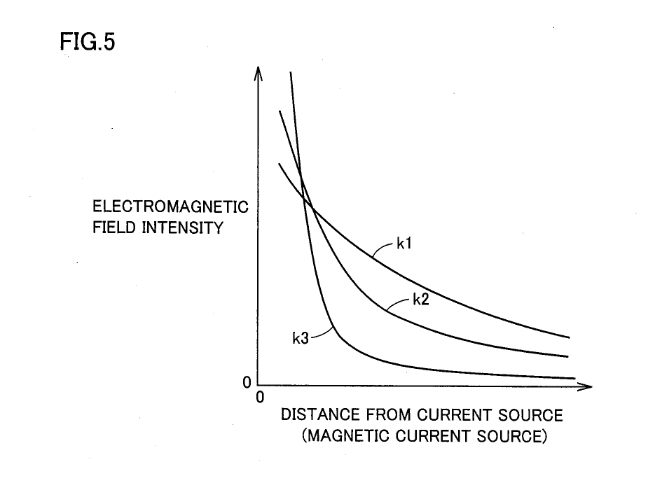

In the electric power transmission system according to the present embodiment, near field (evanescent field) where “static electric field” of electromagnetic field is dominant is made use of in order to improve efficiency in transmission and reception of electric power. FIG. 5 is a diagram showing relation between a distance from a current source (magnetic current source) and electromagnetic field intensity. Referring to FIG. 5, electromagnetic field is constituted of three components. A curve k1 represents a component inversely proportional to a distance from a wave source and it is referred to as “radiation electric field.” A curve k2 represents a component inversely proportional to a square of a distance from a wave source and it is referred to as “induction electric field.” In addition, a curve k3 represents a component inversely proportional to a cube of a distance from a wave source and it is referred to as “static electric field.” It is noted that, with a wavelength of electromagnetic field being denoted as “λ”, a distance at which “radiation electric field,” “induction electric field,” and “static electric field” are substantially equal in intensity can be expressed as λ/2π.

“Static electric field” is an area where intensity of electromagnetic waves sharply decreases with a distance from the wave source, and in the electric power transmission system according to the present embodiment, near field (evanescent field) where this “static electric field” is dominant is made use of for transmitting energy (electric power). Namely, electric power transmission portion 28 and electric power reception portion 27 (for example, a pair of LC resonance coils) having close natural frequencies are caused to resonate in near field where “static electric field” is dominant, so that energy (electric power) is transmitted from electric power transmission portion 28 to the other electric power reception portion 27. Since this “static electric field” does not propagate energy over a long distance, a resonant method can achieve electric power transmission with less energy loss than electromagnetic waves transmitting energy (electric power) by means of the “radiation electric field” propagating energy over a long distance.

Thus, in the electric power transmission system according to the present embodiment, electric power is transmitted from electric power transmission device 41 to the electric power reception device by causing electric power transmission portion 28 and electric power reception portion 27 to resonate through electromagnetic field. A coefficient of coupling (κ) between electric power transmission portion 28 and electric power reception portion 27 is preferably not greater than 0.1. It is noted that a coefficient of coupling (κ) is not limited to this value and it can take various values at which good electric power transmission is achieved. Generally, in electric power transmission making use of electromagnetic induction, a coefficient of coupling (κ) between the electric power transmission portion and the electric power reception portion is close to 1.0.

Coupling between electric power transmission portion 28 and electric power reception portion 27 in electric power transmission in the present embodiment is referred to, for example, as “magnetic resonant coupling,” “magnetic field resonant coupling,” “electromagnetic field resonance coupling,” or “electric field resonance coupling.”

“Electromagnetic resonance coupling” means coupling including any of “magnetic resonant coupling,” “magnetic field resonant coupling,” and “electric field resonance coupling.”

Since an antenna in a coil shape is adopted for resonant coil 24 of electric power transmission portion 28 and resonant coil 11 of electric power reception portion 27 described herein, electric power transmission portion 28 and electric power reception portion 27 are coupled to each other mainly through magnetic field, and electric power transmission portion 28 and electric power reception portion 27 are in “magnetic resonant coupling” or “magnetic field resonant coupling.”

It is noted that, for example, an antenna such as a meandering line can also be adopted for resonant coils 24, 11, and in this case, electric power transmission portion 28 and electric power reception portion 27 are coupled to each other mainly through electric field. Here, electric power transmission portion 28 and electric power reception portion 27 are in “electric field resonance coupling.”

(First Coolant Device 500)

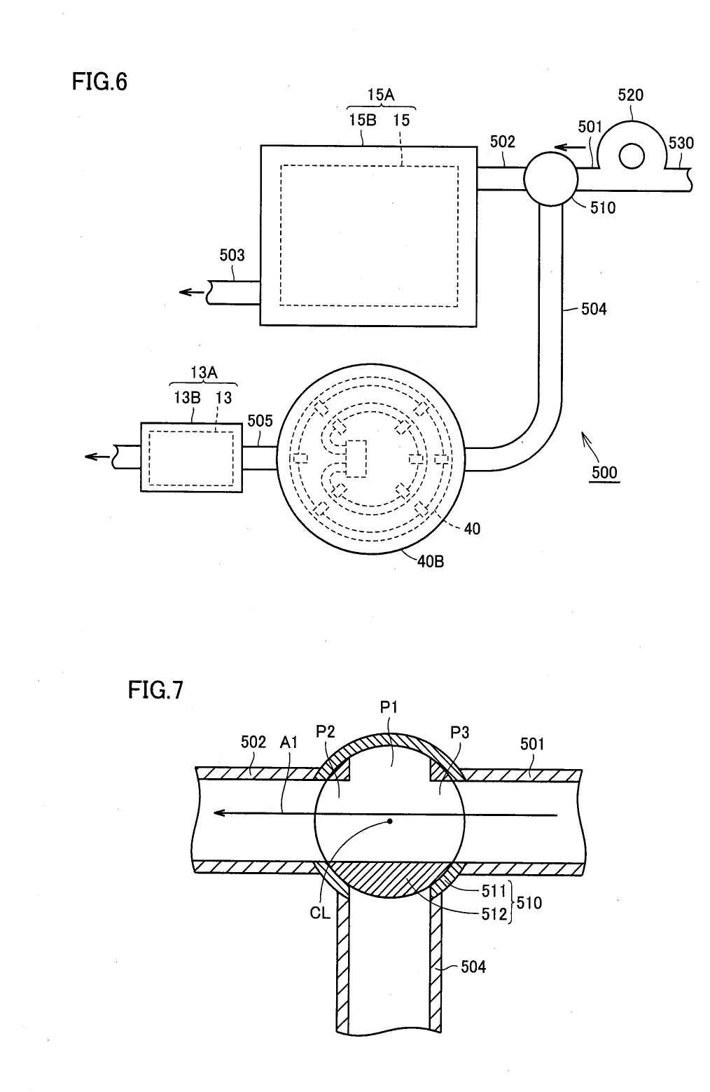

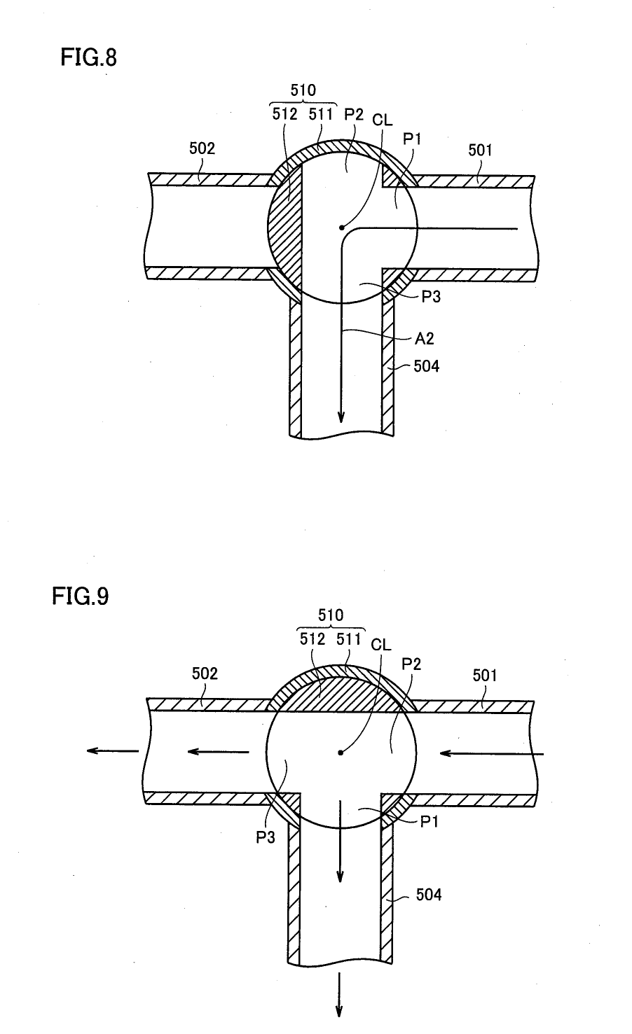

A first coolant device 500 mounted on an electrically powered vehicle in the first embodiment will be described with reference to FIGS. 6 to 9. FIG. 6 is a schematic diagram showing a construction of first coolant device 500, FIG. 7 is a diagram showing a detailed construction and a first state of a flow path switching device of first coolant device 500, and FIGS. 8 and 9 are diagrams showing second and third states of the flow path switching device of first coolant device 500, respectively.

Any of liquid and gaseous coolants for cooling a battery and a charging device may be employed as a coolant shown below. In the present embodiment, air is used by way of example of a gas.

So long as air is lower in temperature than a battery and a charging-related device, air can cool a battery and a charging device by being sent to the battery and the charging device. This is also the case with other gases and liquids without limited to air. Air in an air-conditioned vehicle chamber, outside air, or exclusively conditioned air can be employed as air.

Referring to FIG. 6, electrically powered vehicle 10 in the present embodiment adopts an electric power transmission system making use of wireless charging as described above and incorporates a battery device 15A including battery 15 to be charged with external electric power and a charging device.

Here, battery device 15A includes battery 15 and a battery case 15B accommodating battery 15 so as to allow flow of a coolant therein. The charging device includes electric power reception device 40 used for charging of battery 15, and electric power reception device 40 is accommodated in an electric power reception case 40B in which the coolant for cooling electric power reception device 40 can flow.

For example, not only electric power reception device 40 but also rectifier 13, DC/DC converter 14, power control unit 16, and vehicle ECU 18 (see FIG. 1) fall under charging devices used for charging of battery 15. In the present embodiment, cooling of electric power reception device 40 and rectifier 13 is described.

A rectifier device 13A includes rectifier 13 and a rectifier case 13B accommodating rectifier 13 so as to allow flow of the coolant therein. Electric power reception device 40 includes resonant coil 11, electromagnetic induction coil 12, and capacitor 19. Electric power reception case 40B accommodating these devices such that the coolant can flow in electric power reception device 40 is provided.

Since battery 15 generates heat mainly during charging and running of the electrically powered vehicle, battery 15 should be cooled while battery 15 generates heat. Since the charging device generates heat while electric power is transmitted from electric power transmission device 41 (during charging of battery 15 with external electric power), the charging device should be cooled while the charging device generates heat.

In the present embodiment, first coolant device 500 mounted on electrically powered vehicle 10 is provided to allow switching between a first state in which the coolant is introduced into battery 15 and a second state in which the coolant is introduced into the charging device.

Specifically, first coolant device 500 includes a first main coolant flow path 501 in which the coolant is introduced, a flow path switching device 510 provided in first main coolant flow path 501, a first coolant flow path 502 provided in flow path switching device 510 and leading to battery device 15A, and a second coolant flow path 504 provided in flow path switching device 510 and leading to battery device 15A and rectifier device 13A.

Though battery 15 and rectifier 13 are adopted as components to be cooled in the present embodiment, only battery 15 or DC/DC converter 14, power control unit 16, and vehicle ECU 18 in addition to battery 15 and rectifier 13 can also be cooled.

A first fan 520 for introducing air sent as the coolant into first main coolant flow path 501 and a first coolant introduction flow path 530 are provided for first main coolant flow path 501.

Battery device 15A provided in first coolant flow path 502 is provided with a first exhaust path 503 for exhausting the coolant used for cooling of battery 15. Electric power reception device 40 provided in second coolant flow path 504 is provided with a second exhaust path 505 for exhausting the coolant used for cooling of resonant coil 11, electromagnetic induction coil 12, and capacitor 19. Rectifier device 13A is provided in this second exhaust path 505, and rectifier 13 is cooled by the coolant used for cooling of battery 15. Rectifier 13 can also be accommodated in electric power reception device 40 and then cooled.

Referring to FIG. 7, flow path switching device 510 has a three-way valve structure, and has a housing 511 and a rotary valve 512. Rotary valve 512 is controlled to be rotatable around an axis of rotation CL. Housing 511 is provided with first main coolant flow path 501, first coolant flow path 502, and second coolant flow path 504. Rotary valve 512 accommodated in housing 511 has a first port P1, a second port P2, and a third port P3.

Referring to FIG. 7, second port P2 of rotary valve 512 communicates with first coolant flow path 502 and third port P3 communicates with first main coolant flow path 501. First port P1 is closed by housing 511.

In this state, first main coolant flow path 501 and first coolant flow path 502 communicate with each other, and the first state in which air for the coolant can be introduced into battery 15 (in a direction of an arrow A1 in the figure) is established.

The first state includes also a state that a valve is controlled such that, when an amount of coolant which flows from first main coolant flow path 501 to first coolant flow path 502 and an amount of coolant which flows from first main coolant flow path 501 to second coolant flow path 504 are compared with each other, an amount of coolant which flows to first main coolant flow path 501 is greater than an amount of coolant which flows to second coolant flow path 504, other than a case that all coolants flow from first main coolant flow path 501 to first coolant flow path 502 as described above. Therefore, the first state mainly means a case that the coolant is introduced from first main coolant flow path 501 to first coolant flow path 502. This is also the case with an embodiment below.

Referring to FIG. 8, rotary valve 512 is rotated clockwise by 90° C. from the state shown in FIG. 7. Thus, first port P1 communicates with first main coolant flow path 501 and third port P3 communicates with second coolant flow path 504. Second port P2 is closed by housing 511.

In this state, first main coolant flow path 501 and second coolant flow path 504 communicate with each other, and the second state in which air for the coolant can be introduced into electric power reception device 40 and rectifier device 13A (in a direction shown with an arrow A2 in the figure) is established.

The second state also includes a state that the valve is controlled such that, when an amount of coolant which flows from first main coolant flow path 501 to first coolant flow path 502 and an amount of coolant which flows from first main coolant flow path 501 to second coolant flow path 504 are compared with each other, an amount of coolant which flows to second main coolant flow path 504 is greater than an amount of coolant which flows to first coolant flow path 502, other than a case that all coolants flow from first main coolant flow path 501 to second coolant flow path 504. Therefore, the second state mainly means the coolant is introduced from first main coolant flow path 501 to second coolant flow path 504. This is also the case with an embodiment below.

Referring to FIG. 9, rotary valve 512 is rotated clockwise by 90° C. from the state shown in FIG. 8 or rotary valve 512 is rotated counterclockwise by 180° C. from the state shown in FIG. 7. Thus, first port P1 communicates with second coolant flow path 504, second port P2 communicates with first main coolant flow path 501, and third port P3 communicates with first coolant flow path 502.

In this state, first coolant flow path 502 and second coolant flow path 504 communicate with first main coolant flow path 501, and a third state in which air for the coolant can be introduced into battery device 15A, electric power reception device 40, and rectifier device 13A is established.

Here, since battery 15 generates heat mainly during charging and running of the electrically powered vehicle as described above, the first state or the third state is preferably selected for cooling battery 15.

In the first state, though air is sent to battery device 15, no air is sent to electric power reception device 40. Therefore, the first state is preferred when cooling of battery 15 is necessary and cooling of the charging device is not necessary.

Since the charging device generates heat while electric power is transmitted from electric power transmission device 41, selection of the second state is preferred.

In a case that control for switching between the states in response to ON/OFF of charging is carried out as control for switching between the states, a temperature sensor for sensing a temperature of battery 15 and a temperature sensor for sensing a temperature of the charging device are provided, whether or not cooling is necessary is determined based on a temperature obtained from each temperature sensor, and control for switching between the states is carried out.

Thus, in the electrically powered vehicle in the present embodiment, switching between the first state in which the coolant is introduced into battery 15 and the second state in which the coolant is introduced into the charging device can be made. Thus, cooling of battery 15 and cooling of the charging device can be realized by using flow path switching device 510 and single first fan 520. Consequently, a coolant introduction device for cooling the battery and cooling the charging device used for charging of the battery can efficiently be made use of. Thus, a size of the coolant introduction device can be reduced and reduction in power consumption can be expected.

By reducing a size of a cooling device, a cooling device for cooling the battery and cooling the charging device used for charging of the battery can also efficiently be mounted in a limited space in the electrically powered vehicle.

In addition, the third state in which air for the coolant can be introduced into battery 15, electric power reception device 40, and rectifier 13 can also be selected so that each device can efficiently be cooled. It is not essential to allow selection of the third state, and the first state and the second state should only be selectable. This is also the case with each embodiment below.

In the electric power transmission system employing wireless charging, an amount of heat generation from battery 15 and the charging device is different for each time of charging based on various factors such as position displacement between electric power transmission device 41 and electric power reception device 40. In such a case as well, the coolant introduction device in the present embodiment can be employed.

Battery 15, electric power reception device 40, and rectifier 13 are arranged in battery case 15B, electric power reception case 40B, and rectifier case 13B, respectively, and air is introduced into the inside of each case, however, battery 15, electric power reception device 40, and rectifier 13 can also be cooled by adopting such a construction that air is blown to impinge on battery case 15B, electric power reception case 40B, and rectifier case 13B. This is also the case with each embodiment below.

### Second Embodiment

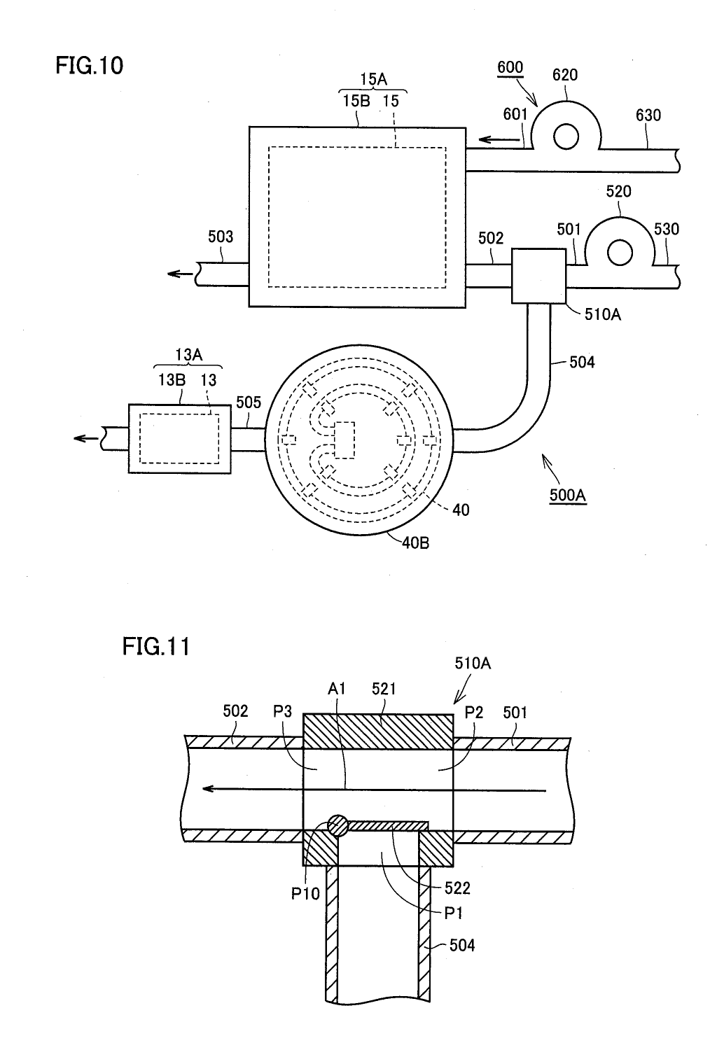

The electrically powered vehicle incorporating the electric power transmission system according to the present embodiment will now be described with reference to FIGS. 10 to 13. Since the present embodiment is different from the first embodiment described above in a construction of a cooling device, elements the same as or corresponding to those in the first embodiment have the same reference numbers allotted and redundant description may not be repeated.

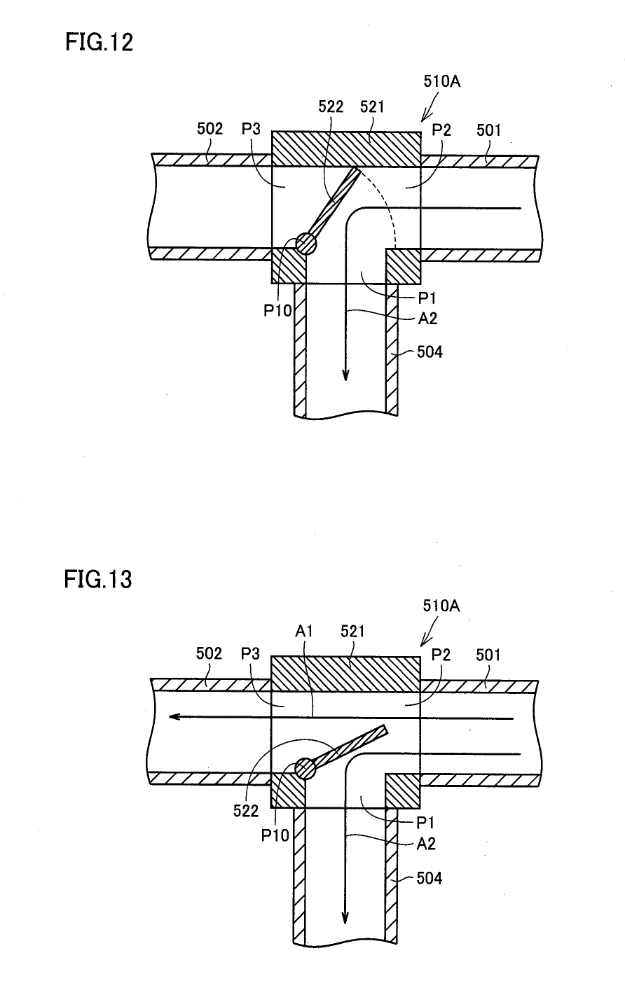

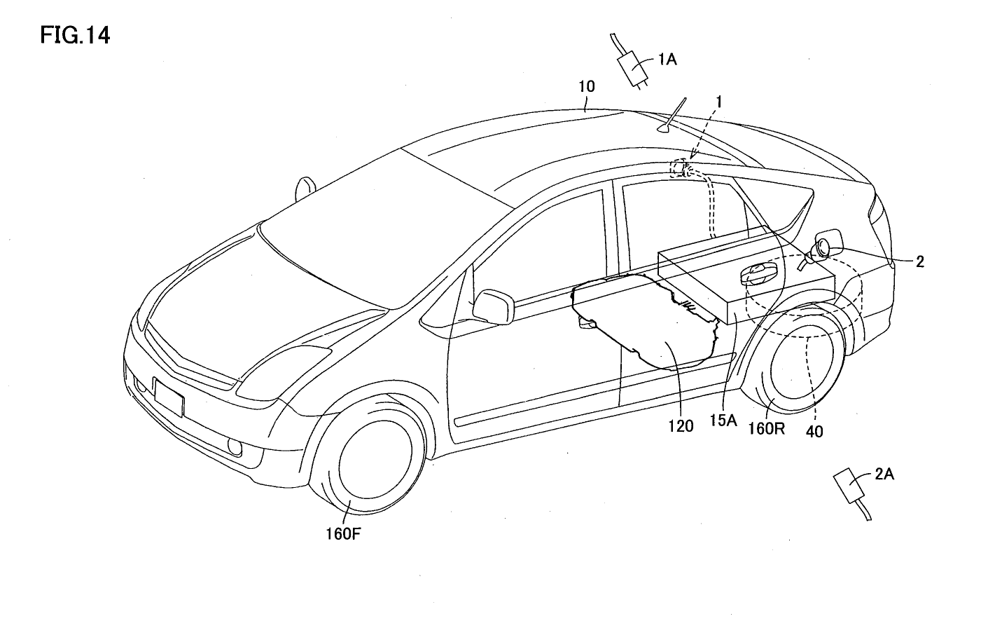

FIG. 10 is a schematic diagram showing a construction of a first coolant device and a second coolant device mounted on the electrically powered vehicle in the present embodiment, FIG. 11 is a diagram showing a detailed construction and a first state of a flow path switching device of the first coolant device, and FIGS. 12 and 13 are diagrams showing second and third states of the flow path switching device of the first coolant device, respectively.

In the electrically powered vehicle according to the present embodiment, a second coolant device 600 is provided in addition to a first coolant device 500A basically similar in construction to the first embodiment.

Second coolant device 600 has a second main coolant flow path 601 provided in battery device 15A. A second fan 620 for introducing air sent as the coolant into second main coolant flow path 601 and a second coolant introduction flow path 630 are provided for second main coolant flow path 601.

First coolant device 500A in the present embodiment includes a flow path switching device 510A different in construction from flow path switching device 510 employed in the first embodiment. Other features are the same.

Referring to FIG. 11, this flow path switching device 510A has a three-way valve structure, and has a housing 521 and an on-off valve 522. On-off valve 522 is controlled to be pivotable around an axis of rotation P10. Housing 521 is provided with first main coolant flow path 501, first coolant flow path 502, and second coolant flow path 504. Housing 521 has first port P1, second port P2, and third port P3.

Referring to FIG. 11, on-off valve 522 closes first port P1. Thus, second port P2 communicates with first main coolant flow path 501 and third port P3 communicates with first coolant flow path 502.

In this state, first main coolant flow path 501 and first coolant flow path 502 communicate with each other, and the first state in which air for the coolant can be introduced into battery device 15A (in the direction shown with arrow A1 in the figure) is established.

Referring to FIG. 12, on-off valve 522 is pivoted from the state shown in FIG. 11 to set a state in which third port P3 is closed. Thus, second port P2 communicates with first main coolant flow path 501 and first port P1 communicates with second coolant flow path 504.

In this state, first main coolant flow path 501 and second coolant flow path 504 communicate with each other, and the second state in which air for the coolant can be introduced into electric power reception device 40 and rectifier device 13A which are charging-related devices (in the direction shown with arrow A2 in the figure) is established.

Referring to FIG. 13, on-off valve 522 is pivoted to a neutral position. Thus, first port P1 communicates with second coolant flow path 504, second port P2 communicates with first main coolant flow path 501, and third port P3 communicates with first coolant flow path 502.

In this state, first coolant flow path 502 and second coolant flow path 504 communicate with first main coolant flow path 501, and the third state in which air for the coolant can be introduced into battery device 15A, electric power reception device 40, and rectifier device 13A is established.

Here, as in the first embodiment, since battery 15 generates heat mainly during charging and running of the electrically powered vehicle, the first state or the third state is preferably selected for cooling of battery 15.

In the first state, though air is sent to battery device 15A, no air is sent to electric power reception device 40. Therefore, the first state is preferred when cooling of battery 15 is necessary and cooling of the charging device is not necessary.

Since the charging device generates heat while electric power is transmitted from electric power transmission device 41, selection of the second state is preferred.

In the present embodiment, by providing second coolant device 600 in addition to first coolant device 500, control for cooling battery 15 can finely be carried out. For example, by operating second coolant device 600 while the first state is selected in first coolant device 500 so that the coolant is introduced mainly into battery 15, the coolant is introduced into battery 15 also from second coolant device 600, and hence efficiency in cooling of battery 15 can be enhanced.

When the second state is selected in first coolant device 500 as well, efficiency in cooling of battery 15 can be enhanced by operating second coolant device 600.

Second coolant device 600 is preferably lower in cooling capability than first coolant device 500. Thus, a size of second coolant device 600 can be reduced. Cooling capability means an amount of coolant introduced into battery device 15A per unit time in a case that air at the same temperature is introduced from first coolant device 500 and second coolant device 600 into battery device 15A. Therefore, in a case that a cross-sectional area of each flow path is the same, a fan lower in capacity than first fan 520 is employed for second fan 620.

In the present embodiment, while control for cooling of battery 15 is facilitated, cooling of the battery can be stabilized. In addition, the coolant introduction device for cooling the charging-related device used for charging of the battery can efficiently be made use of. Thus, the coolant introduction device can be reduced in size and reduction in power consumption can be expected.

By reducing a size of a cooling device, a cooling device for cooling the battery and cooling the charging device used for charging of the battery can also efficiently be mounted in a limited space in the electrically powered vehicle.

### Third Embodiment

The electrically powered vehicle incorporating the electric power transmission system according to the present embodiment will now be described with reference to FIGS. 14 to 16. The present embodiment is different from the first and second embodiments described above in further including a charging portion connected to an externally provided power feed connector, in addition to electric power reception device 40 including electric power reception portion 27 receiving electric power in a non-contact manner from electric power transmission device 41 including externally provided electric power transmission portion 28. Elements the same as or corresponding to those in the first and second embodiments have the same reference numbers allotted and redundant description may not be repeated.

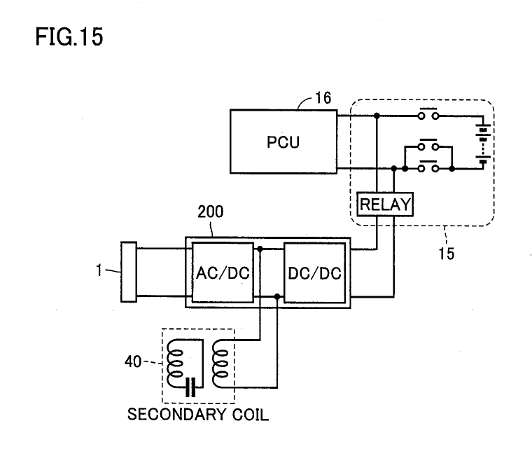

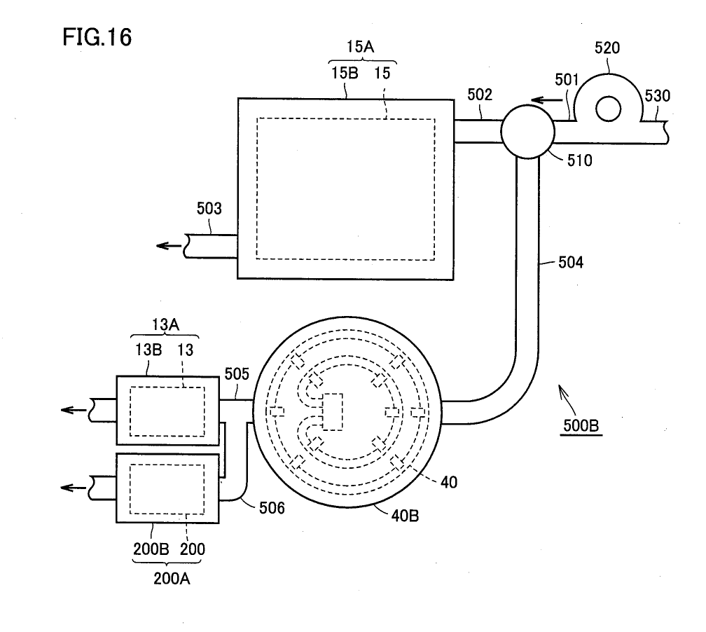

FIG. 14 is a perspective view showing a construction of the electrically powered vehicle in the present embodiment, FIG. 15 is a diagram showing a circuit of the electric power reception device, a charger, a charging control unit, and the battery mounted on the electrically powered vehicle in the present embodiment, and FIG. 16 is a schematic diagram showing a construction of a first coolant device mounted on the electrically powered vehicle in the present embodiment.

Referring to FIG. 14, electrically powered vehicle 10 in the present embodiment is provided with a fuel tank 120 in a portion located under a rear seat in a passenger compartment. Battery device 15A is arranged in the rear of the rear seat in electrically powered vehicle 10. Electric power reception device 40 is arranged below battery device 15A, with a rear floor panel lying between electric power reception device 40 and battery device 15A.

A charging portion 1 is provided in a rear fender on the right of electrically powered vehicle 10, and an oil supply portion 2 is provided in a rear fender on the left. In the example shown in this FIG. 14, charging portion 1 and oil supply portion 2 are provided in side surfaces of the vehicle different from each other, however, charging portion 1 may be provided on the right and oil supply portion 2 may be provided on the left, or they may be provided on the same side surface (on the left or right). Charging portion 1 and oil supply portion 2 may be provided in a front fender, without limited to the rear fender.

In an oil supply operation, fuel is supplied by inserting an oil supply connector 2A into oil supply portion 2 (a fuel supply portion). Fuel such as gasoline supplied from oil supply portion 2 is stored in fuel tank 120.

In a charging operation, electric power is supplied by inserting a power feed connector 1A into charging portion 1 (an electric power supply portion). Power feed connector 1A is a connector for charging with electric power supplied from a commercial power supply (for example, single-phase AC 100 V in Japan). For example, a plug connected to a common household power supply is employed as power feed connector 1A.

Referring to FIG. 15, in the present embodiment, charging portion 1 and electric power reception device 40 are connected to a charger 200. Battery 15 is connected to charger 200 and a charging control unit 300 is connected to battery 15. Thus, in the present embodiment, charging portion 1 adapted to contact charging and electric power reception device 40 adapted to non-contact electric power reception are connected to charger 200 adapted to both of them.

Therefore, charger 200 converts electric power fed from charging portion 1 into charging power for battery 15, and converts electric power received from electric power reception device 40 into charging power for battery 15. Charger 200 is accommodated in a charger case 200B accommodating charger 200 so as to allow flow of the coolant therein. Charger 200 and charger case 200B are collectively referred to as a charger device 200A.

A construction of a first coolant device 500B in the present embodiment will be described with reference to FIG. 16. A basic construction is the same as that of first coolant device 500 in the embodiment. A difference is that a branch flow path 506 is provided in second exhaust path 505 for exhausting the coolant used for cooling of electric power reception device 40, and charging device 200A is provided in this branch flow path 506. Thus, charger 200 can be cooled by the coolant used for cooling of electric power reception device 40. Charger 200 can also be cooled as it is accommodated in electric power reception device 40.

Thus, a function and effect the same as in the first embodiment can be achieved and charger 200 can be cooled.

A function and effect the same as in the second embodiment can be obtained by not only adopting first coolant device 500B but also adding second coolant device 600 as in the second embodiment.

Though the electric power transmission device and the electric power reception device including electromagnetic induction coils 12 and 23 are exemplified in each embodiment above, the present invention is also applicable to a resonant-type non-contact electric power transmission and reception device including no electromagnetic induction coil.

Specifically, on a side of electric power transmission device 41, a power supply portion (AC power supply 21, high-frequency electric power driver 22) may directly be connected to resonant coil 24, without providing electromagnetic induction coil 23. On a side of electric power reception device 40, rectifier 13 may directly be connected to resonant coil 11, without providing electromagnetic induction coil 12.

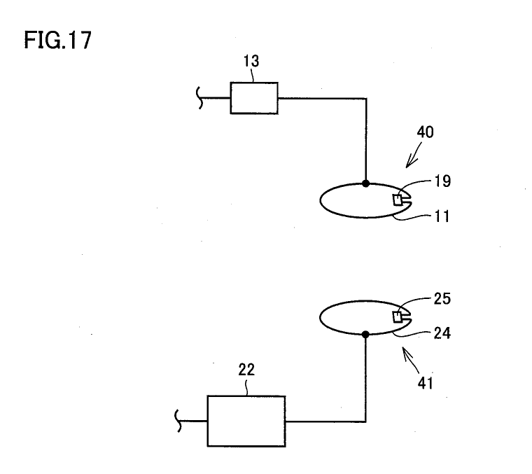

FIG. 17 shows electric power transmission device 41 and electric power reception device 40 without electromagnetic induction coil 23, based on the structure shown in FIG. 1. Electric power transmission device 41 and electric power reception device 40 shown in FIG. 17 can be applied mutatis mutandis to all the embodiments described above.

Flow path switching device 510 in the present first embodiment and flow path switching device 510A in the present second embodiment are not limited as such, and they can take various forms so long as an amount of coolant to first coolant flow path 502 and second coolant flow path 504 can be adjusted.

It should be understood that the embodiments and the examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 charging portion; 1A power feed connector; 2 oil supply portion; 2A oil supply connector; 10 electrically powered vehicle; 11 resonant coil; 12 electromagnetic induction coil; 13 rectifier; 13A rectifier device; 13B rectifier case; 15B battery case; 14 DC/DC converter; 15 battery; 15A battery device; 16 power control unit; 17 motor unit; 18 vehicle ECU; 19, 25, 95, 98 capacitor; 20 external power feed device; 21 AC power supply; 22 high-frequency electric power driver; 23, 92, 97 electromagnetic induction coil; 24, 94 resonant coil; 26 control unit; 27, 96 electric power reception portion; 28, 93 electric power transmission portion; 40, 91 electric power reception device; 40B electric power reception case; 41, 90 electric power transmission device; 42 parking space; 89 electric power transmission system; 95 capacitor; 99 resonant coil; 120 fuel tank; 200 charger; 200A charger device; 500, 500A, 500B first coolant device; 501 first main coolant flow path; 502 first coolant flow path; 503 first exhaust path; 504 second coolant flow path; 505 second exhaust path; 506 branch flow path; 510, 510A flow path switching device; 511, 521 housing; 512 rotary valve; 520 first fan; 522 on-off valve; 530 first coolant introduction flow path; 600 second coolant device; 601 second main coolant flow path; 620 second fan; and 630 second coolant introduction flow path.

1. A vehicle, comprising:
a battery charged with external electric power;
a charging device used for charging of said battery; and
a first coolant device for introducing a coolant for cooling said battery and said charging device into said battery and said charging device,
said first coolant device being provided to allow switching between a first state in which said coolant is introduced mainly into said battery and a second state in which said coolant is introduced mainly into said charging device.

2. The vehicle according to claim 1, wherein
said first coolant device includes
a main coolant flow path in which said coolant is introduced,
a flow path switching device provided in said main coolant flow path,
a first coolant flow path provided in said flow path switching device and leading to said battery, and
a second coolant flow path provided in said flow path switching device and leading to said charging device, and
said flow path switching device is provided to allow switching between said first state in which said first coolant flow path is allowed to communicate with said main coolant flow path to introduce said coolant mainly into said battery and said second state in which said second coolant flow path is allowed to communicate with said main coolant flow path to introduce said coolant mainly into said charging device.

3. The vehicle according to claim 1, wherein
when cooling of said battery is necessary and cooling of said charging device is not necessary, said first state is selected for said first coolant device.

4. The vehicle according to claim 1, wherein
said battery further includes a second coolant device for introducing a coolant for cooling said battery.

5. The vehicle according to claim 4, wherein
in cooling said battery at least said second coolant device is used to introduce said coolant into said battery.

6. The vehicle according to claim 4, wherein
when said first state is selected, said coolant is introduced into said battery by using said second coolant device.

7. The vehicle according to claim 4, wherein
said second coolant device is lower in cooling capability than said first coolant device.

8. The vehicle according to claim 1, wherein
said second state is selected during charging of said battery with said external electric power.

9. The vehicle according to claim 1, wherein
said charging device includes an electric power reception device receiving electric power in a non-contact manner from an externally provided electric power transmission portion.
